(19) United States
(12) Patent Application Publication
(10) Pub. No.: US 2019/0263069 A1
(43) Pub. Date: Aug. 29, 2019

(54) 3D PRINTING METHOD AND SYSTEM

(71) Applicant: ZHUHAI SEINE TECHNOLOGY CO., LTD., Zhuhai (CN)

(72) Inventors: Wei CHEN, Zhuhai (CN); Darong MA, Zhuhai (CN); Wei JIANG, Zhuhai (CN); Xiaokun CHEN, Zhuhai (CN)

(21) Appl. No.: 16/405,608

(22) Filed: May 7, 2019

Related U.S. Application Data
(63) Continuation of application No. PCT/CN2017/083911, filed on May 11, 2017.

(30) Foreign Application Priority Data
Nov. 14, 2016 (CN) 201611000284.X

(51) Int. Cl. B29C 64/393

(52) U.S. Cl. CPC B29C 64/393; B33Y 10/00

(57) ABSTRACT

A 3D printing method of the present disclosure includes: step S101 for printing an Nth sliced layer of a to-be-printed object according to a first print path, where N is a positive integer greater than or equal to 1; step S102 for printing an (N+1)th sliced layer of the to-be-printed object according to a second print path, where the second print path is a reverse path of the first print path; and step S103 for repeatedly performing S101 and S102 till the printing is completed. The present disclosure can realize a relatively high printing efficiency.

### CROSS-REFERENCE TO RELATED APPLICATION

This application is a continuation application of International Application No. PCT/CN2017/083911, filed on May 11, 2017, which claims priority to Chinese Patent Application No. 201611000284.X, filed on Nov. 14, 2016. The above enumerated patent applications are incorporated herein by reference in their entity.

### TECHNICAL FIELD

The present disclosure relates to the field of three-dimensional (3D) printing and, in particular, to a 3D printing method and system.

### BACKGROUND

As one of rapid prototyping technologies, 3D printing can realize the production of more complex shapes and is hence widely studied and applied.

However, since the 3D printing is processed layer by layer, and the 3D object has a certain thickness, after multi-layer stacking, the accumulated moving time of the printhead for returning to the start position is long, affecting the printing efficiency.

### SUMMARY

The present disclosure provides a 3D printing method and system, which can achieve a relatively high printing efficiency.

In one aspect, the present disclosure provides a 3D printing method, which includes:

step S101, for printing an Nth sliced layer of a to-be-printed object according to a first print path, where N is a positive integer greater than or equal to 1;

step S102, for printing an (N+1)th sliced layer of the to-be-printed object according to a second print path, where the second print path is a reverse path of the first print path; and

step S103, for repeatedly performing step S101 and step S102 till printing is completed.

In a second aspect, the present disclosure provides a 3D printing system includes:

a printhead, configured to eject a printing material;

a drive controller, configured to control the printhead to print according to print data; and

a processor, configured to generate the print data, where the print data is configured to include the following steps:

step S101, for printing an Nth sliced layer of a to-be-printed object according to a first print path, where N is a positive integer greater than or equal to 1;

step S102, for printing an (N+1)th sliced layer of the to-be-printed object according to a second print path, where the second print path is a reverse path of the first print path; and

step S103, for repeatedly performing step S101 and step S102 till printing is completed.

In the 3D printing method and system of the present disclosure, the 3D printing method can include the following steps: step S101, for printing an Nth sliced layer of a to-be-printed object according to a first print path, where N is a positive integer greater than or equal to 1; step S102, for printing an (N+1)th sliced layer of the to-be-printed object according to a second print path, where the second print path is a reverse path of the first print path; and step S103, for repeatedly performing step S101 and step S102 till printing is completed. In this way, when two adjacent layers are switched during the printing process, the printhead does not perform a non-printing return operation, but continuously prints directly on the next layer, thereby improving the printing efficiency.

### DESCRIPTION OF THE DRAWINGS

In order to clearly illustrate embodiments of the present disclosure or technical solutions in the existing technologies, drawings for the embodiments of the present disclosure or the existing technologies are briefly described below. Obviously, the drawings described below are some embodiments of the present disclosure, and for ordinary technical personnel in the art, other drawings can also be obtained based on these accompany drawings under the premise that no creative effort is made.

FIG. 1A is a schematic view of a print path of a printhead in the existing technologies;

FIG. 1B is a schematic view showing another print path of a printhead in the existing technologies;

FIG. 2A schematically shows the printhead of FIG. 1A returning form an end position to a start position after completing a layer-print product;

FIG. 2B schematically shows the printhead of FIG. 1B returning form an end position to a start position after completing a layer-print product;

FIG. 3 is a schematic flow chart of a 3D printing method according to some embodiments of the present disclosure;

FIG. 4 is a schematic flow chart of printing an Nth sliced layer of a to-be-printed object based on a first print path according to some embodiments of the present disclosure;

FIG. 5 is another schematic flow chart of printing an Nth sliced layer of a to-be-printed object based on a first print path according to some embodiments of the present disclosure;

FIG. 6 is a schematic flow chart of another 3D printing method according to some embodiments of the present disclosure;

FIG. 7 is a schematic flow chart of determining an end position of a first print path according to some embodiments of the present disclosure;

FIG. 8 schematically shows a path direction of a first print path when a printhead performs an odd number of moves along a secondary scanning direction on an Nth sliced layer according to some embodiments of the present disclosure;

FIG. 9 schematically shows a path direction of a second print path when the printhead performs an odd number of moves along a secondary scanning direction on an Nth sliced layer;

FIG. 10 schematically shows a path direction of a first print path when a printhead performs an even number of moves in a secondary scanning direction on an Nth sliced layer according to some other embodiments of the present disclosure;

FIG. 11 schematically shows a path direction of a second print path when the printhead performs an even number of moves in a secondary scanning direction on an Nth sliced layer according to some other embodiments of the present disclosure; and

FIG. 12 is a schematic structural diagram of a 3D printing system according to some other embodiments of the present disclosure.

### DETAILED DESCRIPTION

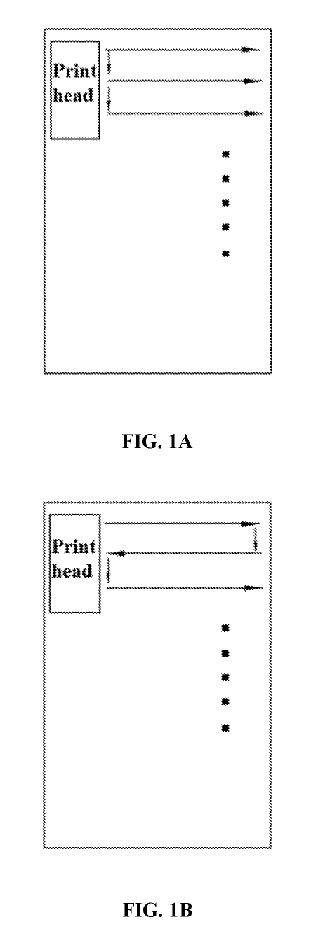

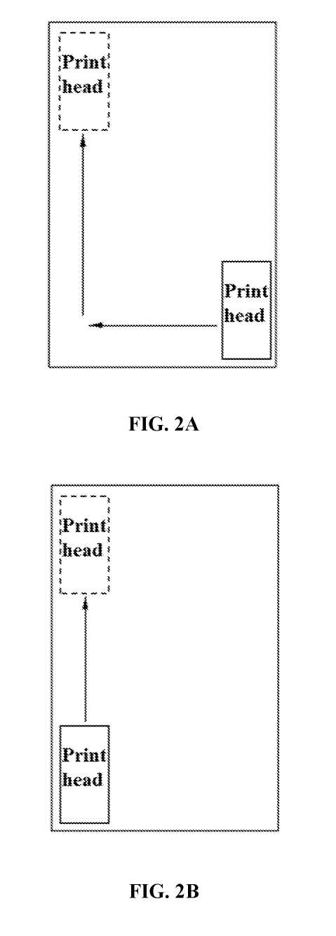

At present, the basic principle of 3D printing is based on 3D model layering, followed by layer-by-layer successively stacking materials to produce a 3D object. Each sliced layer printed by a printhead is a layer-print product. Before the printhead starts to print, the printhead can be set at a start position. Each sliced layer can be printed by starting from the start position till all the sliced layers are printed. FIG. 1A is a schematic view of a print path of a printhead in the existing technologies. FIG. 1B is a schematic view showing another print path of a printhead in the existing technologies. Referring to FIGS. 1A and 1B, after the printhead finishes each layer-print product, the printhead needs to return to the start position from an end position. FIG. 2A schematically shows the printhead of FIG. 1A returning from the end position to the start position after finishing a layer-print product. FIG. 2B schematically shows the printhead of FIG. 1B returning from the end position to the start position after finishing a layer-print product. Referring to FIGS. 2A and 2B, in the process of returning to the start position, the printhead resets the position by selecting a relatively short path, and does not perform printing in the process of returning.

However, since the 3D printing is processed layer by layer, and the 3D object has a certain thickness, after multi-layer stacking, the accumulated moving time of the printhead for returning to the start position is long, affecting the printing efficiency.

The present disclosure provides a 3D printing method and system, which can achieve a relatively high printing efficiency. To make the objectives, technical solutions, and advantages of the present disclosure clearer, the technical solutions in the embodiments of the present disclosure will be clearly and completely described in conjunction with the accompany drawings in the embodiments of the present disclosure. Obviously, the embodiments described below are part of embodiments but not all of the embodiments of the present disclosure. All other embodiments obtained by those skilled in the art based on the embodiments of the present disclosure under the premise that no creative effort is made are within the scope of the present disclosure.

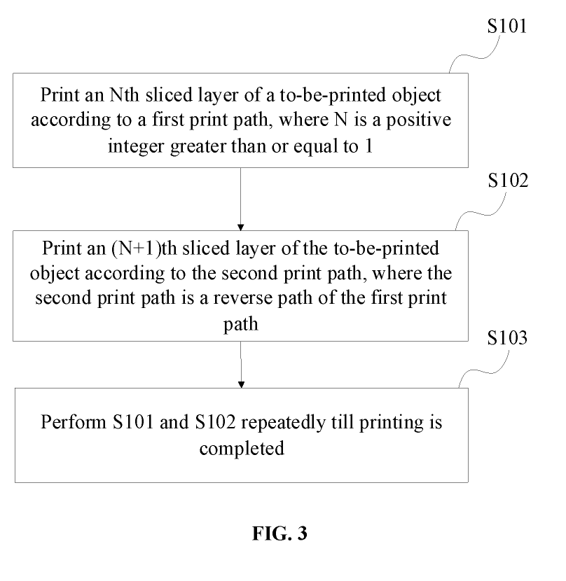

FIG. 3 is a schematic flow chart of a 3D printing method according to some embodiments of the present disclosure. As shown in FIG. 3, the 3D printing method may include the following steps:

step S101, for printing an Nth sliced layer of a to-be-printed object according to a first print path, where N is a positive integer greater than or equal to 1;

step S102, for printing an (N+1)th sliced layer of the to-be-printed object according to a second print path, where the second print path is a reverse path of the first print path; and

step S103, for repeatedly performing step S101 and step S102 till printing is completed.

Herein, the 3D printing method is suitable for a 3D printing system. Before printing, the to-be-printed object needs to be sliced, and printing can be performed layer by layer according to sliced layers. On each sliced layer of the to-be-printed object, the printhead always performs a whole layer printing process along a certain path, thereby completing a layer-print product. For example, printing of the Nth sliced layer of the to-be-printed object can be taken as an example. Before printing, the printhead is located at a start position of the sliced layer and moves along the first print path. During the moving process, the printhead may selectively eject a printing material at a corresponding position to perform printing formation on the Nth sliced layer.

In the present disclosure, the first print path or the second print path may refer to a path formed by the printhead moving to perform the printing of the sliced layer, but not specifically indicate a working path when the printhead performs the printing. In general, there is a certain distance between the start position of the printhead to a position where the printhead starts to print. While the printhead moves in the distance, the printhead can complete a state transition from a stationary state to an accelerated-speed state, and to a constant-speed state, so as to eject the printing material at the constant-speed state. The end position of the printhead has similar features as the start position of the printhead. Therefore, the first print path or the second print path of the present disclosure is a movement path formed from the start position to the end position.

After completing the printing of the Nth sliced layer, the printhead at this time does not need to return to the start position, but directly starting from the end of the original first print path, starts printing (N+1)th sliced layer adjacent to the Nth sliced layer along the second print path. When sizes of adjacent sliced layers are the same, the direction of each segment of the second print path is opposite to the direction of each segment of the first print path. For example, the second print path is a reverse path along an opposite direction of the first print path. When the sizes of the adjacent sliced layers are different, the end position of the second print path and the start position of the first print path may not coincide with each other. In this way, the printhead can complete the printing of the adjacent two layers under a reciprocating motion.

After printing the adjacent two layers, according to similar procedures, printing for the remaining layers of the to-be-printed object can be performed until printing of the entire to-be-printed object is completed. For every two adjacent layers, one layer is printed based on the first print path and the other layer is printed based on the second print path. In this way, when the 3D printing of the to-be-printed object is performed, after complete printing of each layer, the printhead can directly perform printing the next adjacent layer without empty returning process. Thus, it can be avoided that in the existing technologies, after printing a first layer, the printhead need to return to the start position before the next layer can be printed, as such the return time of the printhead can be effectively saved, and the 3D printing speed and print efficiency can be improved.

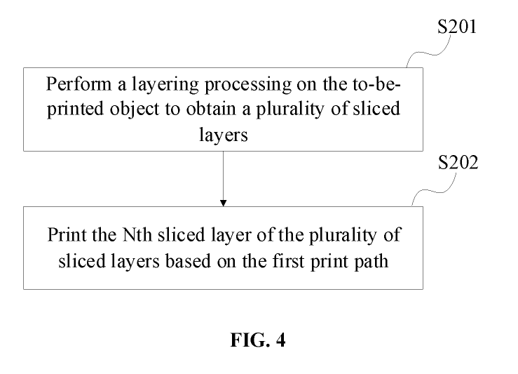

FIG. 4 is a schematic flow chart of printing an Nth sliced layer of a to-be-printed object based on a first print path according to some embodiments of the present disclosure. As shown in FIG. 4, the process of printing the Nth sliced layer of the to-be-printed object according to the first print path may include the following sub-steps:

S201, for performing a layering processing on the to-be-printed object to obtain a plurality of sliced layers.

Since the to-be-printed object contains three-dimensional scale data, to facilitate performing printing, the 3D object needs to be converted into a data format. For example, first the 3D object information of the to-be-printed object can be obtained by scanning method, and then the 3D object information can be converted into a data format, such as STL format, PLY format, WRL format, etc., that can be recognized by a slice layering software. Because the 3D object information is in units of layers, after scanned and treated by data processing, the 3D object needs to be slice layered by the slice layering software and each layer can be processed to generate layer images. Each layer image can be analyzed to obtain print information of each layer. Finally, the print information of each layer can then be converted to layer-print data to facilitate performing layered printing.

S202, for printing the Nth sliced layer of the plurality of sliced layers based on the first print path.

After converting the three-dimensional scale of the to-be-printed object into the print data of each layer, each layer can be printed according to the print data of each layer. In some embodiments, the Nth sliced layer of the plurality of sliced layers may be printed according to the first print path, so that the printing operation of the Nth sliced layer can be completed.1

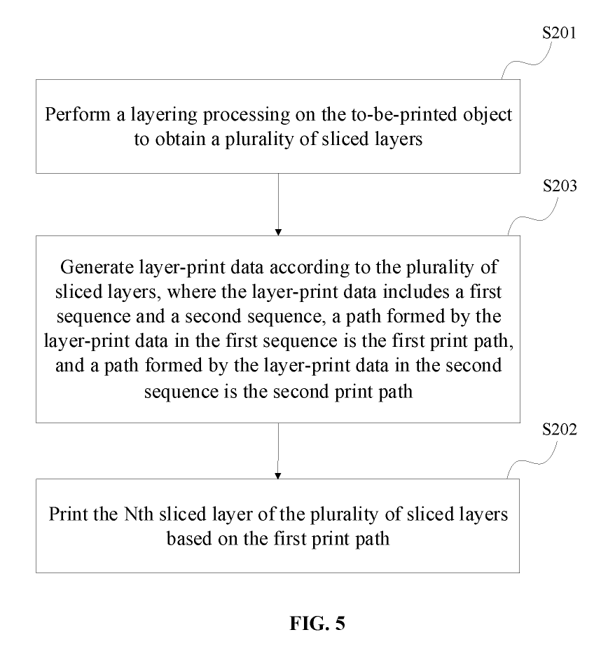

FIG. 5 is another schematic flow chart of printing an Nth sliced layer of a to-be-printed object based on a first print path according to some embodiments of the present disclosure. As shown in FIG. 5, as an implementation method, in order to complete the printing process of different paths, after the to-be-printed object may be performed with layering treatment to obtain a plurality of sliced layers, the following steps are performed:

S203, for generating the layer-print data according to the plurality of layers, where the layer-print data includes a first sequence and a second sequence, a path formed by the layer-print data in the first sequence is the first print path, and a path formed by the layer-print data in the second sequence is the second print path.

Since when the layered printing is performed, the layer-print data of each sliced layer is fixed, for example, completely consistent with the physical shape of the to-be-printed object in the layer. In order to make the printhead form different print paths, the layer-print data includes the first sequence and the second sequence, and the first sequence and the second sequence are mutually reversed and respectively correspond to different print paths. When the layer-print data forms a path according to the first sequence, the printhead can move along the first print path and perform printing; and when the layer-print data forms a path according to the second sequence, the printhead can move along the second print path and perform printing. As described above, when the layer-print data of the Nth sliced layer is used for printing in the first sequence, the layer-print data of the adjacent (N+1)th sliced layer is used for printing in the second sequence. For example, the sequences of the layer-print data of the two adjacent layers are different and reversed.

The foregoing first sequence and second sequence are mutually reversed. For example, a storage mode and transmission mode of the layer-print data in the first sequence are opposite to those of the layer-print data in the second sequence. In some embodiments, each layer includes M*N matrix data dots (e.g., pixels). The layer-print data of each layer can be data included in each data dot. When stored, the layer-print data of the Nth sliced layer is stored according to the sequence of the data dots, and the layer-print data of the (N+1)th sliced layer is stored according to a reverse sequence of the data dots. When transmitted, the layer-print data of the Nth sliced layer is transmitted according to the sequence of the data dots, and the layer-print data of the (N+1)th sliced layer is transmitted according to a reverse sequence of the data dots.

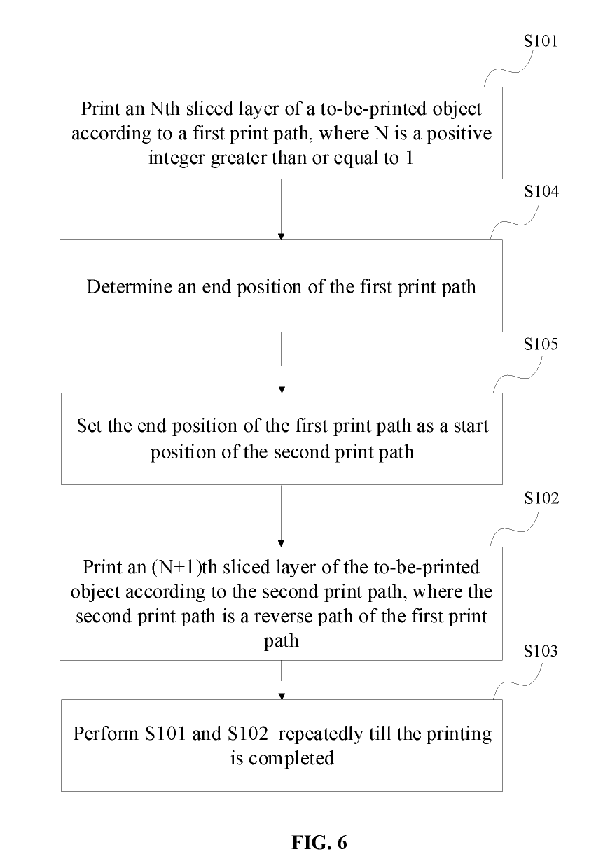

In addition, FIG. 6 is a schematic flow chart of another 3D printing method according to some embodiments of the present disclosure. As shown in FIG. 6, when the printhead of the 3D printing system performs the printing of the Nth sliced layer and the (N+1)th sliced layer, in order to position the printhead, before the (N+1)th sliced layer of the to-be-printed object is printed according to the second print path, the method further includes:

S104, for determining an end position of the first print path; and

S105, for setting the end position of the first print path as a start position of the second print path.

In steps S104 and S105, the first print path and the second print path are reverse paths with directions opposite to each other, thus subsequent printing can be performed by obtaining the end position of the first print path and directly setting it as the start position of the second print path. In this way, the printhead can perform uninterrupted moving for printing, reducing the unnecessary moving of the printhead.

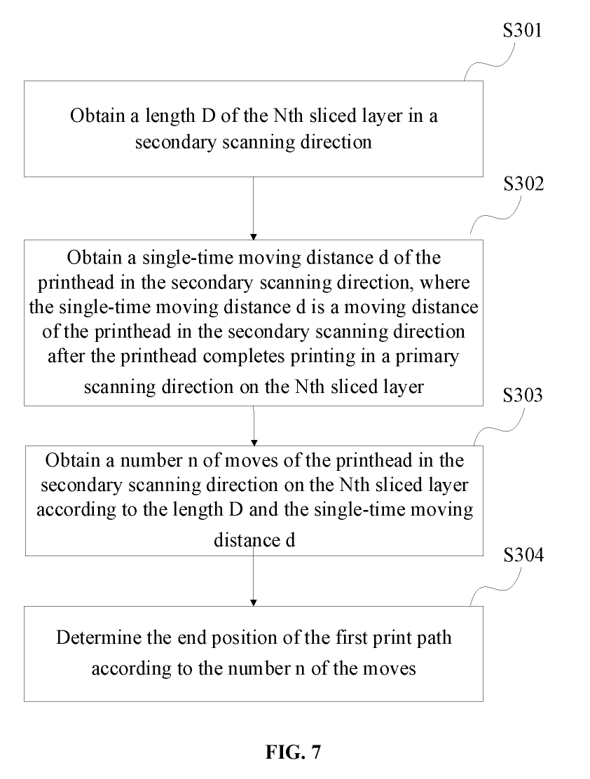

FIG. 7 is a schematic flow chart of determining an end position of a first print path according to some embodiments of the present disclosure. As shown in FIG. 7, when determining the end position of the first print path, the method may further include the following steps:

S301, for obtaining a length D of the Nth sliced layer in a secondary scanning direction;

S302, for obtaining a single-time moving distance d of the printhead in the secondary scanning direction, the single-time moving distance d being a moving distance of the printhead in the secondary scanning direction after the printhead completes printing in a primary scanning direction on the Nth sliced layer;

S303, for obtaining, according to the length D and the single-time moving distance d, a number n of moves of the printhead along the secondary scanning direction on the Nth sliced layer; and

S304, for determining, according to the number n of the moves, the end position of the first print path.

On a plane of each sliced layer, the printhead has movements in both an X-axis direction and an Y-axis direction, where the X-axis direction can be the primary scanning direction, and the Y-axis direction can be the secondary scanning direction. Each time, the printhead always performs printing along the primary scanning direction, and after completing each printing job along the primary scanning direction and moving to an edge of the sliced layer, moves a certain distance along the secondary scanning direction and changes to the next section of path in the primary scanning direction. The single-time moving distance of the printhead in the secondary scanning direction is always the same. In this way, when determining the end position of the first print path, a length D of the Nth sliced layer in the secondary scanning direction, e.g., the Y-axis, can be first obtained, and the single-time moving distance d of the printhead in the secondary scanning direction can be then obtained. Because the printhead always moves in one direction in the secondary scanning direction without returning back, the number n of the moves of the printhead in the secondary scanning direction on the Nth sliced layer can be obtained according to the length D and the single-time moving distance d. For example, the number n of the moves can be calculated according to the following equation n=(D/d)−1.

After obtaining the number n of the moves of the printhead in the secondary scanning direction on the Nth sliced layer, the end position of the first print path can be determined according to the number n. Generally, depending on the parity of n, the end position of the first print path may exhibit two different locations. In some embodiments, determining the end position of the first print path according to the number n of the moves may specifically include:

if the number n of the moves is an odd number, determining the end position of the first print path being located on a same side of the start position of the first print path; and if the number n of the moves is an even number, determining the end position of the first print path being located on a different side from the start position of the first print path.

The first print path is formed by moving back and forth along an X-axis direction of the Nth sliced layer and then moving to an Y-axis after moving to the edge of the Nth sliced layer. Therefore, if the number n of the moves is an odd number, the first print path may be moving along the X-axis direction for odd number of times and to the end position of the first print path is on the same side as the start position of the first print path along the X-axis direction; while if the number n of the moves is an even number, the first print path may be moving along the X-axis direction for even number of times and the end position of the first print path is at a different side from the start position.

Correspondingly, the start position of the second print path coincides with the end position of the first print path, and moves reversely along the opposite direction of the first print path. Because the end position of the first print path varies with the parity of the number of the moves, and the start position of the second print path also varies accordingly.

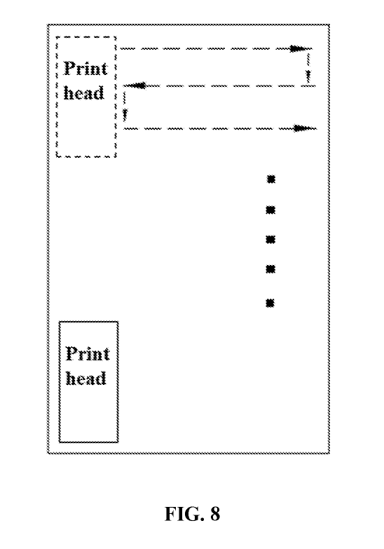

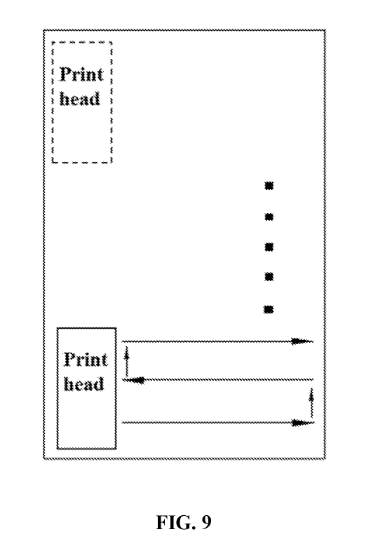

FIG. 8 schematically shows a path direction of a first print path when a printhead performs an odd number of moves along a secondary scanning direction on an Nth sliced layer according to some embodiments of the present disclosure. As shown in FIG. 8, the number of the moves of the printhead in the secondary scanning direction on the Nth sliced layer being an odd number can be taken as an example, and correspondingly, the end position of the first print path on the Nth sliced layer is on the same side as the start position. FIG. 9 schematically shows a path direction of a second print path when the printhead performs an odd number of moves along a secondary scanning direction on an Nth sliced layer. As shown in FIG. 8 and FIG. 9, the direction of the first print path is in a path direction shown in FIG. 8, and after the printhead performs the printing of the Nth sliced layer along the first print path, the printhead can further perform printing according to the second print path shown in FIG. 9. After repeating the first print path and the second print path, a plurality of layer-printing products can be obtained and stacked layer-by-layer to form the 3D to-be-printed object.

In some embodiments, the 3D printing method includes the following steps: step S101, for printing an Nth sliced layer of a to-be-printed object according to a first print path, where N is a positive integer greater than or equal to 1; step S102, for printing an (N+1)th sliced layer of the to-be-printed object according to a second print path, where the second print path is a reverse path of the first print path; and step S103, for repeatedly performing S101 and S102 till the printing is completed. In this way, when two adjacent layers are switched during the printing process, the printhead does not perform a non-printing return operation, but continuously prints directly on the next layer, thereby improving the printing efficiency.

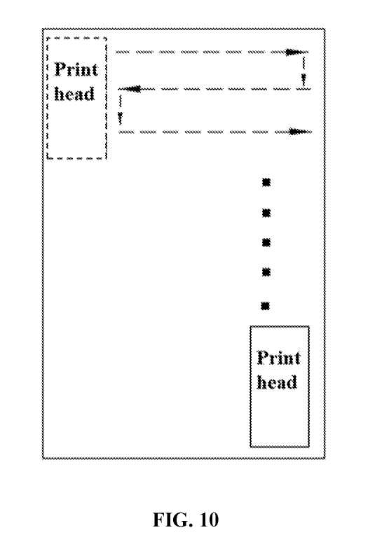

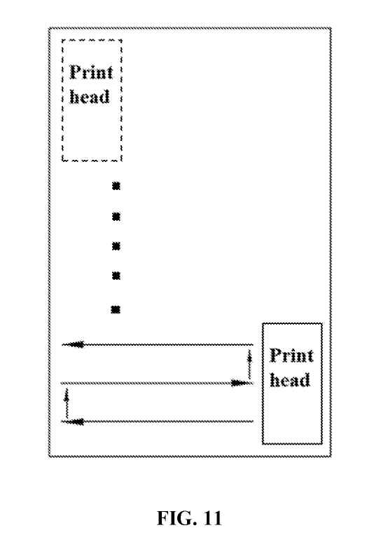

FIG. 10 schematically shows a path direction of a first print path when a printhead performs an even number of moves in a secondary scanning direction on an Nth sliced layer according to some other embodiments of the present disclosure. FIG. 11 schematically shows a path direction of a second print path when the printhead performs an even number of moves in a secondary scanning direction on an Nth sliced layer according to some embodiments of the present disclosure. As shown in FIG. 10 and FIG. 11, the length of the printhead in the secondary scanning direction on the Nth sliced layer is D, and the single-time moving distance of the printhead in the secondary scanning direction is d, and the number of moves of the printhead in the secondary scanning direction on the Nth sliced layer is n, where n=(D/d)−1. The number of moves n of the printhead on the Nth sliced layer in the secondary scanning direction being an even number can be taken as an example, correspondingly, the end position of the first print path on the Nth sliced layer is on different sides from the start position. As shown in FIG. 10, the direction of the first print path is in a path direction shown in FIG. 10, and after the printhead performs the printing of the Nth sliced layer along the first print path, the printhead can further perform printing according to the second print path shown in FIG. 11. After repeating the first print path and the second print path, a plurality of layer-print products can be obtained and stacked layer-by-layer to form the 3D to-be-printed object.

In some embodiments, the number of moves of the printhead in the secondary scanning direction on the Nth sliced layer is an even number, so the end position and the start position of the first print path are on the different sides, thereby forming a second print path different from the second print path when the number of moves is an odd number.

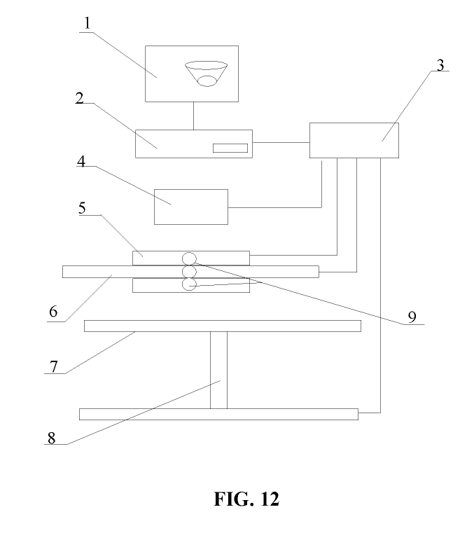

FIG. 12 is a schematic structural diagram of a 3D printing system according to some other embodiments of the present disclosure. The 3D printing system can perform the 3D printing method of the foregoing embodiments. As shown in FIG. 12, the 3D printing system may include:

a printhead 5, configured to eject a printing material;

a drive controller 3, configured to control the printhead to print according to print data; and

a processor 2, configured to generate the print data, where the print data is configured to include the following steps:

step S101, for printing an Nth sliced layer of a to-be-printed object according to a first print path, where N is a positive integer greater than or equal to 1;

step S102, for printing an (N+1)th sliced layer of the to-be-printed object according to a second print path, where the second print path is a reverse path of the first print path; and

step S103, for repeatedly performing step S101 and step S102 till printing is completed.

The processor 2 may be a processing terminal or the like. The processor 2 are electrically connected to the drive controller 3 to output the print data to the drive controller 3. The drive controller 3 can control the printhead 5 to eject the printing material to complete the layer-print product. A plurality of layer-print products can be stacked layer-by-layer to form a 3D to-be-printed object 1. A printing material container 4 can be configured to supply the printhead 5 with the printing material. The print paths of the printhead 5 for two adjacent layers are respectively the first print path and the second print path which are opposite to each other. The processor in the 3D printing system can implement the 3D printing method in the foregoing embodiments in a manner of software, hardware or a combination of software and hardware, and details are not described herein again.

In some embodiments, the 3D printing system further includes two light lamps 9 for photocuring the printing material, and two light lamps 9 are respectively disposed on two sides of the printhead 5. The two light lamps 9 can be turned on simultaneously or alternately to illuminate the printing material, so as to cure the printing material. The printhead 5 and the light lamps 9 can all be slidably disposed on a guide track 6.

In some embodiments, the light lamps 9 can be LED lamps.

In addition, the 3D printing system may further include a printing platform 7 and a lifting frame 8. A top of the printing platform 7 includes a printing plane for placing the to-be-printed object thereon. The lifting frame 8 is disposed at a bottom of the printing platform 7 for adjusting a height of the printing platform 7 during the printing process. In this way, in the 3D printing process, after each layer is printed, the lifting frame 8 is lowered to a certain height, and then the printhead 5 performs printing on another layer.

In this embodiment, the 3D printing system includes a printhead configured to eject the printing material; a drive controller configured to control the printhead to print according to print data; and a processor configured to generate the print data. The print data is configured to include the following steps: step S101, for printing an Nth sliced layer of a to-be-printed object according to a first print path, where N is a positive integer greater than or equal to 1; step S102, for printing an (N+1)th sliced layer of the to-be-printed object according to a second print path, where the second print path is a reverse path of the first print path; and step S103, for repeatedly performing the steps S101 and S102 till the printing is completed. In this way, when two adjacent layers are switched during the printing process, the printhead does not perform a non-printing return operation, but continuously prints directly on the next layer, and thus the printing efficiency is relatively high.

One of ordinary skill in the art should understand that all or part of the steps of implementing each of the method embodiments described above may be accomplished by hardware associated with the program instructions. The aforementioned program can be stored in a computer readable storage medium. When executed, the program can implement the steps of the foregoing method embodiments. The foregoing storage medium includes various media that can store program codes, such as a ROM, a RAM, a magnetic disk, or an optical disk.

Finally, it should be noted that the above embodiments are merely illustrative of the technical solutions of the present disclosure and are not intended to be limit the present disclosure. Although the present disclosure has been described in detail with reference to the foregoing embodiments, those skilled in the art should understand that the technical solutions described in the foregoing embodiments may be modified, or some or all of the technical features may be equivalently substituted; and the modifications or substitutions do not make the corresponding technical solutions deviate from the scope of technical solutions of each of embodiments of the present disclosure.

What is claimed is:

1. A three-dimensional (3D) printing method, comprising:
step S101, printing, according to a first print path, an Nth sliced layer of a to-be-printed object, wherein N is a positive integer greater than or equal to 1;
step S102, printing, according to a second print path, an (N+1)th sliced layer of the to-be-printed object, wherein the second print path is a reverse path of the first print path; and
step S103, repeatedly performing the step 101 and the step 102, till printing is completed.

2. The 3D printing method according to claim 1, wherein printing the Nth sliced layer of the to-be-printed object according to the first print path comprises:
performing layering processing on the to-be-printed object to obtain a plurality of sliced layers; and
printing the Nth sliced layer of the plurality of sliced layers according to the first print path.

3. The 3D printing method according to claim 2, wherein after performing the layering processing on the to-be-printed object to obtain the plurality of the layers, the method further comprises:
generating layer-print data according to the plurality of the sliced layers, wherein the layer-print data includes a first sequence and a second sequence, a path formed by the layer-print data in the first sequence is the first print path, and a path formed by the layer-print data in the second sequence is the second print path.

4. The 3D printing method according to claim 3, wherein the first sequence and the second sequence are reversed to each other.

5. The 3D printing method according to claim 3, wherein when transmitted, the layer-print data includes the first sequence and the second sequence that are mutually reversely transmitted.

6. The 3D printing method according to claim 3, wherein when stored, the layer-print data includes the first sequence and the second sequence that are mutually reversely stored.

7. The 3D printing method according to claim 1, wherein before printing the (N+1)th sliced layer of the to-be-printed object according to the second print path, the method further comprises:
determining an end position of the first print path; and
setting the end position of the first print path as a start position of the second print path.

8. The 3D printing method according to claim 7, wherein determining the end position of the first print path comprises:
obtaining a length D of the Nth sliced layer in a secondary scanning direction;
obtaining a single-time moving distance d of the printhead in the secondary scanning direction, the single-time moving distance d being a moving distance of the printhead in the secondary scanning direction after the printhead completes printing in a primary scanning direction on the Nth sliced layer;
obtaining, according to the length D and the single-time moving distance d, a number n of moves of the printhead along the secondary scanning direction on the Nth sliced layer; and
determining, according to the number n of the moves, the end position of the first print path.

9. The 3D printing method according to claim 8, wherein determining the end position of the first print path according to the number n of the moves comprises:
if the number n of the moves is an odd number, determining that the end position of the first print path is located on a same side of the start position of the first print path; and
if the number n of the moves is an even number, determining that the end position of the first print path is located on a different side of the start position of the first print path.

10. The 3D printing method according to claim 8, wherein:
the end position of the first print path coincides with the start position of the second print path; and
an end position of the second print path and a start position of the first path are coincident or not coincident.

11. A three-dimensional (3D) printing system, comprising:
a printhead, configured to eject a printing material;
a drive controller, configured to control the printhead to print according to print data; and
a processor, configured to generate the print data, wherein the print data is configured to include instructions:
S101, printing, according to a first print path, an Nth sliced layer of a to-be-printed object, wherein N is a positive integer greater than or equal to 1;
S102, printing, according to a second print path, an (N+1)th sliced layer of the to-be-printed object, wherein the second print path is a reverse path of the first print path; and
S103, repeatedly performing the step 101 and the step 102, till printing is completed.

12. The 3D printing system according to claim 11, wherein the print data includes the instructions further causing the print head to:
perform layering processing on the to-be-printed object to obtain a plurality of sliced layers; and
print the Nth sliced layer of the plurality of sliced layers according to the first print path.

13. The 3D printing system according to claim 12, wherein the print data includes the instructions further causing the print head to:
generate layer-print data according to the plurality of the sliced layers, wherein the layer-print data includes a first sequence and a second sequence, a path formed by the layer-print data in the first sequence is the first print path, and a path formed by the layer-print data in the second sequence is the second print path.

14. The 3D printing system according to claim 13, wherein the first sequence and the second sequence are reversed to each other.

15. The 3D printing system according to claim 13, wherein when transmitted, the layer-print data includes the first sequence and the second sequence that are mutually reversely transmitted.

16. The 3D printing system according to claim 13, wherein when stored, the layer-print data includes the first sequence and the second sequence that are mutually reversely stored.

17. The 3D printing system according to claim 11, wherein the print data includes the instructions further causing the print head to:
determine an end position of the first print path; and
set the end position of the first print path as a start position of the second print path.

18. The 3D printing system according to claim 17, wherein the print data includes the instructions further causing the print head to:
obtain a length D of the Nth sliced layer in a secondary scanning direction;
obtain a single-time moving distance d of the printhead in the secondary scanning direction, the single-time moving distance d being a moving distance of the printhead in the secondary scanning direction after the printhead completes printing in a primary scanning direction on the Nth sliced layer;
obtain, according to the length D and the single-time moving distance d, a number n of moves of the printhead along the secondary scanning direction on the Nth sliced layer; and
determine, according to the number n of the moves, the end position of the first print path.

19. The 3D printing system according to claim 18, wherein the print data includes the instructions further causing the print head to:
if the number n of the moves is an odd number, determine that the end position of the first print path is located on a same side of the start position of the first print path; and
if the number n of the moves is an even number, determine that the end position of the first print path is located on a different side of the start position of the first print path.

20. The 3D printing system according to claim 18, wherein:
the end position of the first print path coincides with the start position of the second print path; and
an end position of the second print path and a start position of the first path are coincident or not coincident.
